(19) United States
(12) Patent Application Publication
(10) Pub. No.: US 2012/0178333 A1
(43) Pub. Date: Jul. 12, 2012

(54) Bi-modal Poly-alpha-olefin Blend

(75) Inventors: James Nicholas Fowler, Odessa, TX (US); Enrico Buenacosa, Odessa, TX (US); James Haselman, Austin, TX (US)

(73) Assignee: REXTAC LLC, Odessa, TX (US)

(21) Appl. No.: 13/345,428

(22) Filed: Jan. 6, 2012

Related U.S. Application Data
(60) Provisional application No. 61/430,695, filed on Jan. 7, 2011.

(51) Int. Cl. B32B 7/12; C09J 123/02; B32B 37/12; B32B 27/08; B32B 5/02; C08L 23/02; C08L 23/20

(52) U.S. Cl. 442/398; 525/55; 524/528; 524/502; 525/240; 428/349; 156/334

(57) ABSTRACT

A low viscosity, high tensile strength polymer having a bi-modal molecular weight distribution is produced using a combination of high molecular weight polymer and low molecular weight polymer. The polymer chains have a high content of meso dyads that results in a greater amount of crystalline regions when the polymer is solidified. The low molecular weight chains provide high flow characteristics when the polymer is molten. The process for producing the high content of meso dyads includes the use of an external donor catalyst during the reaction.

### CROSS-REFERENCE TO RELATED APPLICATIONS:

This application claims the benefit of U.S. Provisional Application No. 61/430,695, filed on Jan. 7, 2011.

### STATEMENT REGARDING FEDERALLY SPONSORED RESEARCH OR DEVELOPMENT

Not Applicable

### BACKGROUND OF THE INVENTION

1. Field of the Invention

This invention relates to amorphous polymers. More particularly, it relates to low viscosity, high tensile strength polymers having a bi-modal molecular weight distribution and hot-melt adhesive formulations based thereon.

2. Description of the Related Art Including Information Disclosed Under 37 CFR 1.97 And 1.98

Atactic poly-alpha-olefins (APAOs) are typically used as a hot-melt adhesives, but the APAO must usually be compounded with a significant number and quantities of other substances in order to achieve the desired performance characteristics. A number of existing patents describe a process for making an APAO as well as how such a polymer may be used in a hot-melt adhesive.

U.S. Pat. Nos. 5,302,675, 5,637,665 and 5,681,913 to Sustic et al. describe high tensile strength, amorphous 1-butene/propylene and ethlene/propylene copolymers made using an external donor catalyst.

The process for preparing the 1-butene/propylene copolymer comprises reacting propylene and 1-butene monomers in the presence of a catalyst system comprising:
(a) a solid supported catalyst component prepared by: (i) co-comminuting magnesium halide support base and aluminum tri-halide in a molar ratio from about 8:0.5 to about 8:3 in the absence of added electron donor; and (ii) then co-comminuting the product of step (i) in the absence of added electron donor with sufficient titanium tetra-halide to provide a molar ratio of magnesium halide to titanium tetra-halide from about 8:0.1 to about 8:1.0;
(b) a trialkylaluminum co-catalyst, having from 1 to 9 carbon atoms in each alkyl group in an amount such that the Al/Ti ratio is between about 50:1 and about 500:1; and,
(c) an alkoxy silane component of the formula Rₙ Si(OR′)₄₋ₙ where n=1-3, R=aryl or alkyl and R′=C₁₋₃ alkyl in a sufficient quantity such that the molar ratio of organoaluminum co-catalyst to alkoxy silane is in the range from about 20:1 to about 45:1.

The copolymer produced is said to be characterized by a propylene content of 25 to 50 wt %, a 1-butene content of 75 to 50 wt % and a tensile strength of at least 300 psig.

U.S. Patent Pub. No. US2008/0306194 by Sun et al. describes compositions based on olefin co-polymers said to possess a favorable balance of cohesive strength, adhesion properties, and processibility, which render them especially well-suited for some hot-melt adhesive applications, for example, as elastic attachment adhesives.

U.S. Pat. No. 5,723,546 to Sustic et al. describes low- and high-molecular weight amorphous polyalphaolefin polymer blends having high melt viscosity. The polymer blends include a high molecular weight average, predominantly atactic flexible polyolefin polymer having a heat of fusion of about 15 to 60 J/g, and a low molecular weight average, atactic polyolefin polymer having a heat of fusion of about 0.1 to 20 J/g, wherein the high molecular weight polymer and low molecular weight polymer are sufficiently miscible to impart a single glass transition temperature to the polymer blend, and the low molecular weight polymer is present in an amount sufficient to impart a melt viscosity of greater than about 8,000 cPs at room temperature and a crystallinity below about 25 J/g to the polymer blend.

U.S. Pat. No. 7,517,579 to Campbell et al. describes a hot-melt adhesive based on tackified amorphous-poly-alpha-olefin-bonded structures. The bonded structures include one or more substrates bonded together with a tackified amorphous poly-alpha-olefin adhesive composition. One method of making such a bonded structure is carried out by applying a tackified amorphous poly-alpha-olefin adhesive composition to one or more substrates at a temperature of about 170 degrees Celsius or lower, and joining the substrates to themselves or to one another. The bonded structure is said to have a dynamic peel strength between about 400 and about 1000 grams per 25 millimeters. The bonded structure is said to be suitable for incorporation into a variety of articles, including personal care products, health/medical products, and household/industrial product, for example.

A number of additional prior art references use APAO as a base for a hot-melt adhesive, but additional ingredients are used—such as isotactic polypropylene, thermoplastic polyolefin rubber (TPO) and/or polybutene—to achieve the necessary properties.

U.S. Pat. No. 6,872,279 to Kolowrot et al. describes a sprayable hot-melt adhesive composition that contains 30 weight percent to 70 percent of one or more poly-alpha-olefins; 5 weight percent to 30 weight percent of at least one oil; and 20 weight percent to 60 weight percent of at least one hydrocarbon resin having a softening range of 70° C. to 140° C. The poly-alpha-olefin or the mixture of poly-alpha-olefins has a softening point of 70° C. to 30° C. and a melt viscosity at 190° C. of 1000 mPas to 20,000 mPas. The hot-melt adhesive has a viscosity at 150° C. of 500 mPas to 4000 mPas.

U.S. Pat. Nos. 5,504,169 and 5,420,217 to Canich describe a process for producing amorphous poly-alpha-olefins with a onocyclopentadienyl transition metal catalyst system that are said to be useful for hot-melt adhesives. The process uses a Group IVB transition metal component and a co-catalyst or activator component to polymerize alpha-olefins to produce amorphous poly-alpha-olefins having high molecular weight.

U.S. Pat. No. 6,627,723 to Karandinos et al. describes adhesive alpha-olefin inter-polymers which are largely amorphous and are said to have a rheological behavior that makes them suitable for adhesive use, both without and with minimized amounts of tackifying resins. The poly-alpha olefin inter-polymer may be composed of: A) from 60 to 94 mol % of units derived from one alpha mono-olefin having from 3 to 6 carbon atoms; and, B) from 6 to 40 mol % of units derived from one or more other mono-olefins having from 4 to 10 carbon atoms and at least one carbon atom more than A); and, (optionally) C) from 0 to 10 mol % of units derived from another copolymerizable unsaturated hydrocarbon, different from A and B. The diad [dyad] distribution of component A in the polymer as determined by 13C NMR is said to show a ratio of experimentally determined diad [dyad] distribution over the calculated Bernoullian diad [dyad] distribution of less than 1.07.

### BRIEF SUMMARY OF THE INVENTION

An amorphous polymer that combines low viscosity and high tensile strength is prepared by a unique polymerization process that enhances the meso dyad sequences in the polymer chain. It is contemplated that this results in higher regions of crystallization that act to enhance the cohesive strength of the polymer, even at low viscosities.

A blend of a low molecular weight polymer with a higher molecular weight polymer provides a hot melt formulation that has low viscosity (due to the low molecular weight chains) and high tensile strength (due to the high molecular weight chains). When molten, the low molecular weight chains provide high flow properties and when cool, the low molecular weight chains couple with the high molecular weight chains to provide high tensile strength. This combination of properties results in excellent processing properties with high ultimate strength in use.

A hot melt adhesive that contains the polymer described above may be used for disposable diaper construction and can be applied by spray methods at temperatures below 300° F.

### BRIEF DESCRIPTION OF THE SEVERAL VIEWS OF THE DRAWING(S)

[not applicable]

### DETAILED DESCRIPTION OF THE INVENTION

Typical hot-melt adhesives commonly used in a variety of applications comprise an atactic poly alpha olefin (APAO) polymer. One such application is the lamination of polyethylene and nonwoven fabric in the construction of disposable diapers. One of the deficiencies of the current technology is that the application temperatures of the APAO-based hot melt adhesives are generally higher than desired. A high application temperature is needed due to the relatively high molecular weight of the polymer and its resulting viscosity. But a high molecular weight polymer is needed in order to provide sufficient tensile strength for the application.

The new development disclosed herein is the use of high meso dyad polymer blends to achieve the combination of high tensile strength with low viscosity. It has been found that when similar polymers without the high meso dyad content are used, the performance of the hot-melt adhesive is much lower than the same hot-melt adhesive formulations that contain the polymers of the present invention.

The present invention is based on a low viscosity, high tensile strength polymer with a bi-modal molecular weight distribution. A combination of high molecular weight polymer and low molecular weight polymer produces an adhesive formulation having very desirable qualities. The polymer chains have a high content of meso dyads that result in a higher amount of crystalline regions when the polymer is solidified. The low molecular weight chains provide high flow characteristics when the polymer is molten.

A process for producing the high content of meso dyads may include the use of an external donor catalyst during the reaction. The external donor catalyst is used to create a high level of meso dyads in the polymer backbone that results in higher regions of crystallinity in the polymer. The crystallinity produces a polymer with higher tensile strength even at low molecular weight.

Blending a low molecular weight high meso dyad polymer with a high molecular weight high meso dyad polymer results in a blend that has both low viscosity and high strength which makes it ideally suitable for low application temperature hot melt adhesives. The low molecular weight polymer provides low viscosity that facilitates the lower application temperature. It is contemplated that the higher molecular weight polymer provides high tensile strength by crystallizing with the low molecular weight polymer. It is further contemplated that this is possible because of the higher meso dyad in both polymer backbones.

Particularly preferred viscosity (molecular weight) ranges of the high- and low-molecular weight polymers are as follows: low viscosity—from about 300 cps at 375° F. to about 3000 cps at 375° F.; high viscosity—from about 5000 cps at 375° F. to about 1,000,000 cps at 375° F. or more.

### Example 1 of A Bi-Modal, High Meso Dyad polymer Blend

An 8000-cps (at 375° F.) copolymer (45% butene, 55% propylene) was made according to the process described in U.S. Pat. No. 5,302,675 to Sustic et al. utilizing an external donor catalyst. This polymer was fed to a 40-mm extruder having an L/D of 48:1 at a rate of 50 lbs/hr. A peroxide—namely, 2,5 Dimethyl 2,5-Di-t-butylperoxy Hexane (DHBP; CAS#: 1068-27-5)—was fed to a downstream port of the extruder at a rate of 9.8 ml/min. This extrusion process reduced the 8000-cps polymer down to 625 cps (at 375° F.). The polymer was collected and subsequently blended at a ratio of 70% 625 cps to 30% 8000 cps. The viscosity of the 70/30 blend was 1235 cps (at 375° F.). The resulting blend was then melted in a Nordson Hot Melt unit and applied through a Controlled Fiberization (CF) nozzle with a 0.018-inch orifice at 275° F. onto a polyethylene film which was then laminated to a polypropylene nonwoven fabric. The lamination was then tested by peeling the laminated structure. The resulting peel values (obtained per T-PEEL Test Method ASTM D1876-72) were much higher than any previously-tested APAO hot melt, whether the APAO was blended with a tackifier (such as is described in U.S. Pat. No. 7,517,579 to Campbell) or applied without any added tackifier.

An important element of the present invention is the higher meso dyad component of the polymer. Without this element, the polymer does not have high tensile strength. Another important element is the blend of both high molecular weight and low molecular weight polymers. Using one without the other does not produce the same balance of performance and processibility as when both are used together.

It is expected that the polymers of the current invention could be made in the conventional way such as a liquid pool Ziegler-Natta catalyst reaction. Both low and high molecular weight polymers can be made this way. Alternatively, the low molecular weight polymer can be made by vis-breaking a higher molecular weight polymer through radical scission. This can be accomplished in a number of ways including the use of an appropriate peroxide with heating—or potentially by the application of heat alone. Either route to the associated polymers is within the scope of the present invention.

An important component of the invention is the use of high meso dyad polymers that provide the unique combination of low viscosity and high tensile strength. Any number of other components could be blended with the polymer to achieve a variety of properties. Another important component is the blending of both high and low molecular weight polymers. It is possible when blending the high molecular weight polymer with the low molecular weight polymer that only one of the polymers contains the high tensile strength chains. Although not currently considered ideal, some level of enhanced performance may be possible even if only one of the polymers has the high tensile strength properties.

Polymerization can be done in a number of processes including Ziegler-Natta catalyst polymerization, metallocene catalyst polymerization or radical scission of a higher molecular weight polymer made from either process.

Although the polymers used in the development of the invention were based on propylene/butene—it is anticipated that any olefin homopolymer or co-polymer could work in the same way. For example, any C₂ to C₁₀ olefin might be used in the process. Also, the co-monomer content could range from 0 (i.e., no co-monomer) to about 90%. Although all of these combinations have not as yet been tested, anyone skilled in the art of olefin polymerization would anticipate that a variety of co- or ter-polymer combinations may work.

It is possible that the polymers according to the current invention could also be grafted with a variety of other functional groups for enhanced adhesion to specific substrates. A number of post-reaction processes might be applied without adversely affecting the performance.

Although the invention has been described in detail with reference to certain preferred embodiments, variations and modifications exist within the scope and spirit of the invention as described and defined in the following claims.

What is claimed is:

1. A blended polymer composition that is useful as a hot-melt adhesive consisting essentially of:
a) a high molecular weight, high tensile strength alpha-olefin polymer; and;
b) a low molecular weight, high tensile strength polymer.

2. A blended polymer composition as recited in claim 1 wherein the alpha-olefin polymer is prepared by an atactic poly-alpha-olefin polymerization process that utilizes an external donor catalyst.

3. A composition comprising:
a polymer blend according to claim 1;
a compatible tackifier at a level of from about 0 to about 90% by weight;
a wax at a level of from about 0 to about 80% by weight; and, at least one other olefin polymer at a level of from about 0 to about 90% by weight.

4. An adhesive comprising a polymer according to claim 1.

5. A bonded structure made by a process comprising:
applying an adhesive as recited in claim 4 to a first layer; and,
bonding the adhesive-bearing first layer to a second layer.

6. A blended polymer composition as recited in claim 1 wherein the low molecular weight, high tensile strength polymer is prepared by vis-breaking a polymer in the presence of a peroxide to achieve a viscosity in the range of about 300 cps to about 800 cps.

7. A blended polymer composition as recited in claim 6 wherein the viscosity of the low molecular weight, high tensile strength polymer is about 625 cps.

8. A process for preparing a blended polymer composition comprising:
preparing a first propylene/1-butene copolymer characterized by a propylene content of 25 to 50 weigh percent, a 1-butene content of 75 to 50 weight percent and a tensile strength of at least 300 psig by reacting propylene and 1-butene monomers in the presence of a catalyst system comprising:
(a) a solid supported catalyst component is prepared by the method comprising:
(i) co-comminuting magnesium halide support base and aluminum trihalide in a molar ratio from about 8:0.5 to about 8:3 in the absence of added electron donor; and
(ii) then co-comminuting the product of step (i) in the absence of added electron donor with sufficient titanium tetrahalide to provide a molar ratio of magnesium halide to titanium tetrahalide from about 8:0.1 to about 8:1.0
(b) a trialkylaluminum co-catalyst, having from 1 to 9 carbon atoms in each alkyl group in an amount such that the Al/Ti ratio is between about 50:1 and about 500:1
(c) an alkoxy silane component of the formula Rₙ Si(OR′)₄₋ₙ where n=1-3, R=aryl or alkyl and R′=C₁₋₃ alkyl in a sufficient quantity such that the molar ratio of organoaluminum co-catalyst to alkoxy silane is in the range from about 20:1 to about 45:1
preparing a second propylene/1-butene copolymer by feeding a portion of the first copolymer to an extruder while simultaneously feeding a peroxide to a downstream port of the extruder; and,
blending the first copolymer with the second copolymer.

9. A process as recited in claim 8 wherein the peroxide is 2,5 dimethyl 2,5-di-t-butylperoxy hexane.

10. A process as recited in claim 8 wherein the first copolymer is about 45% butane and about 55% propylene.

11. A process as recited in claim 8 wherein the first copolymer has a viscosity of about 8000 cps (at 375° F.) and the second copolymer has a viscosity of about 625 cps (at 375° F.).

12. A process as recited in claim 8 wherein the first copolymer and second copolymer are blended at a ratio of about 70% second copolymer to about 30% first copolymer.

13. A process as recited in claim 12 wherein the viscosity of the 70/30 blend is about 1235 cps (at 375° F.).

14. A process as recited in claim 9 wherein the peroxide is fed to the extruder at a rate of about 10 milliliters per minute when the first copolymer is fed to the extruder at a rate of about 50 pounds per hour.

15. A lamination made by a process comprising:
melting a polymer blend prepared by a process according to claim 8 in a hot melt unit;
applying the melted polymer blend to a polyethylene film; and,
thereafter laminating a polypropylene nonwoven fabric to the polyethylene film in the region of the applied melted polymer blend.

16. A lamination as recited in claim 15 wherein the melted polymer blend is applied to the polyethylene film through a controlled fiberization nozzle.

17. A process as recited in claim 8 further comprising adding a compatible tackifier at a level of from about 0 to about 90% by weight to the blended copolymers.

18. A process as recited in claim 8 further comprising adding a wax at a level of from about 0 to about 80% by weight to the blended copolymers.

19. A process as recited in claim 8 further comprising adding another olefin polymer at a level of from about 0 to about 90% by weight to the blended copolymers.

20. A process as recited in claim 8 further comprising adding at least one hot-melt adhesive additive to the blended copolymers.
